(19) United States
(12) Patent Application Publication
(10) Pub. No.: US 2005/0021458 A1
(43) Pub. Date: Jan. 27, 2005

(54) Account-enabled on-line devices

(76) Inventor: Rick Rowe, Incline Village, NV (US)

Correspondence Address: WEIDE & MILLER, LTD., 7251 W. LAKE MEAD BLVD., SUITE 530, LAS VEGAS, NV, 89128, US

(21) Appl. No.: 10/921,691

(22) Filed: Aug. 18, 2004

Related U.S. Application Data
(63) Continuation-in-part of application No. 10/376,180, filed on Feb. 27, 2003.
Application No. 10/376,180 is a continuation of application No. 09/497,788, filed on Feb. 3, 2000, now abandoned.

(51) Int. Cl. G06F 17/60

(52) U.S. Cl. 705/39

(57) ABSTRACT

A system and method are provided for enabling the operation of one or more functions of electronic devices. A user establishes a financial account with a financial account provider, the account having associated funds. The user obtains an electronic device, such as a music player or image display device, the device configured so that one or more functions will not operate without receiving authorization from a service provider. The user provides financial account information to the service provider to pay for a service, and the service provider transmits information, such as a key, to the electronic device to enable operation. In one embodiment, the user transmits financial account information to the service provider, which associates that information with information regarding the user's device. In use, the electronic device establishes a communication link over the Internet to the service provider and transmits a device i.d.

### RELATED APPLICATION INFORMATION

This application is a continuation-in-part of U.S. application Ser. No. 10/376,180, filed Feb. 27, 2003, which is a continuation of U.S. application Ser. No. 09/497,788, filed Feb. 3, 2000.

### FIELD OF THE INVENTION

The present invention relates to methods and devices for permitting monetary transactions, such as the transfer of funds and the payment of monies, and commercial transactions, such as the purchase of goods.

### BACKGROUND OF THE INVENTION

A variety of methods and devices are currently available for facilitating the purchase of goods or services and the transfer of money. Some of the devices include cash, checks and credit cards. Some of the methods include by mail or in-person payments and wire transfers. These current methods and devices have numerous limitations, some of which are evident when considering a variety of situations.

One limitation relates to the ability of minors to make purchases. In the past, minors have generally made purchases in cash or check either tendered directly to the vendor at the vendor's location or mailed to the vendor. With the advent of the Internet and telephonic phone orders, consumers are now offered the ability to purchase goods on-line or over the phone, remote from the vendor offering the goods or services. A primary advantage or purchasing goods in these manners is that the time delay associated with mailing an order to the vendor is eliminated. In either case, however, to realize these speed advantages, the customer must tender payment to the remote vendor at the time the order is placed instead of mailing payment to the vendor. As such, nearly all on-line and telephonic purchases are facilitated by use of a credit card. A user places an order and provides their credit card information, either directly to a representative of the vendor or via data input on-line. A retailer then uses the card information to receive payment from the authority issuing the credit to the user of the credit card.

Generally, minors do not have access to credit cards. One reason for this is that under the law, minors are not necessarily legally bound to their actions. Thus, a credit issuing authority which issues a card to a 17 year old may find that it can not force the minor to pay any debts incurred by using the card. In addition, parents wishing to teach their children financial responsibility often do not wish to provide cards to their children where they can not monitor and control the expenditures by the child.

ATM or “automated teller machine” cards are available which are linked to a bank account. These cards permit a user to withdraw funds from their account, such as at a cash dispensing machine. Some of these cards may also be accepted by retailers, both on the Internet and at the retailer's location. A significant problem with these cards is that they are linked to the user's primary bank account. If the user's card information is intercepted, such as during an on-line transaction, a thief may be able to completely empty the user's primary banking account of all funds. In addition, a user may not even be aware that their card has been misplaced or lost for a long period of time during which another party may find the card and access their account.

Currently, there is also no convenient means for providing gifts or promotions to consumers which is compatible both with standard retail store and on-line purchasing. For example, a gift giver may travel to a store and purchase a “gift certificate” to the store. The gift certificate comprises a paper check, magnetic striped card or similar item. The recipient of the gift may travel to the store and present the gift certificate to serve as payment for goods. Unfortunately, the recipient of the gift certificate must travel to the store to use it. In many situations, this is undesirable, such as when the gift recipient lives far from the store where it was purchased.

Another problem with gift certificates is that they are limited in their acceptance. Both those who give and receive gift certificates desire the ability to use the gift certificate at a wide variety of locations, permitting the gift recipient maximum latitude in selecting their gift. Gift certificates are sometimes available for use at a number of stores at a particular location. These gift certificates are issued by a central authority, such as a mall at which all of the stores are located. These certificates are not otherwise accepted, however.

With the continued development of the Internet and electronic devices, greater numbers of devices are enabled via their connection to the Internet. For example, various electronic devices are configured to obtain operating or other information via the Internet. In many cases, continued operation of the device, or at least access to updated information, requires payment of fees to the information provider.

It is desirable to provide one or more methods and devices which serve to facilitate monetary and commercial transaction in a manner overcoming the above-stated limitations.

### SUMMARY OF THE INVENTION

The present invention comprises one or more methods and apparatus for facilitating financial transactions.

One or more embodiments of the invention comprise a method of a customer establishing a financial account with an account provider, the account having features particularly useful in facilitating monetary and commercial transactions. This method comprises the steps of providing customer data to the account provider, establishing an account type, assigning a value limit for the account, depositing funds in the financial account in an amount not exceeding the value limit, assigning the financial account an expiration date after which access to the financial account is generally prohibited by a user, and generating an account signature for use in establishing later entitlement to access the financial account.

One or more embodiments of the invention comprise an account which is particularly useful in facilitating monetary and commercial transactions. The financial account has monetary funds associated therewith which may be debited from the account, an expiration date associated therewith after which access to the account is prevented, a maximum funds value comprising the maximum funds which may be associated with the account, and account data for use in establishing entitlement to access the account.

One or more embodiments of the invention comprise a method of facilitating a commercial transaction comprising establishing a financial account, the account having a maximum funds limit, funds associated therewith not exceeding the limit, an expiration date after which commercial transactions are prohibited, and account access data, a customer activating the account in order to utilize the account, determining if the customer wishes to utilize the account to facilitate a commercial transaction, determining if access to the account is permitted if it is determined that the customer wishes to utilize the account, and if access is permitted, and debiting funds from the account in order to facilitate the transaction.

One embodiment of the invention comprises an electronic device and a method and system for enabling operation of the device. Preferably, the device is a computing device including a processor, memory and an information transceiver. The device is configured to establish a communication link, preferably over the Internet, with a service provider in order to obtain information to enable one or more functions of the device. In one embodiment, the device obtains a key to enable operation of the device. In another embodiment, the device may obtain information such as data representing music content or images for play or display by the device to the user. In another embodiment, the device may be configured to obtain other information, such as: a meal menu or cookbook service where meals can be selected and recipes assessed and accessed; a grocery inventory permitting grocery items to be selected for delivery; a restaurant service where reservations may be made or menus perused and orders placed; weather information; and motion picture menus and data representing motion pictures for display to the user, among other things.

In one embodiment, multiple services may be linked or associated. For example, a user might access a recipe. If the user needs some or all of the ingredients for that recipe, the user might be able to order those ingredients for delivery. In one embodiment, the source of the recipe might be a grocery provider. In another embodiment, however, the recipe may be provided by one provider, and then the groceries delivered or provided by a second provider, such as by the recipe provider accessing a directory of grocery providers who are closest to the user or will deliver to the user's location. In any event, the user's financial account may be utilized to pay for the goods/services as described herein.

In one embodiment, a party establishes a financial account, such as in the manner and having the form as described herein. The financial account is preferably established with a financial account provider and has funds associated therewith.

In one embodiment, the party provides financial account information, such as an account number, to the service provider. The service provider associates this account information with one or more devices, such as with a device i.d. for the device.

In use, the electronic device establishes a communication link with the service provider, such as a server of the service provider via the Internet. The device transmits identifying information, such as a device i.d., to the service provider. The service provider utilizes the device i.d. to obtain the associated financial account information and then utilize that information to contact the financial account provider and obtain payment.

The service provider then configures and provides information to the electronic device. In one embodiment, the service provider may configure a key which is used by the electronic device to enable operation of one or more features. The key may have an expiration date, such as to enable the operation of the device for a period of time such as a week or month. The information may also comprise data representing music or images which is used by the device to generate music or images.

In another embodiment, the user may provide the financial account information to the electronic device. The electronic device may transmit that information to the service provider when the device needs information, such as an operating key or the like. In this manner, the financial account information remains associated with the user's device.

In accordance with this aspect of the invention, a convenient means is provided for enabling the operation of a “pay for use” electronic device. The method and system have particular applicability to Internet accessing devices, such as music players which obtain music content from music service providers.

The method and system is configured to take advantage of the financial accounts of the invention. For example, a party may purchase an electronic device as a gift. That party may establish and fund an account. When the party gives the gift, the recipient may simply turn on and use the device (e.g. the device transmitting i.d. information to the service provider, who then accesses the already established financial account to obtain payment and then send device enabling information). A party may associate one device with one account, or multiple devices with multiple accounts.

Further objects, features, and advantages of the present invention over the prior art will become apparent from the detailed description of the drawings which follows, when considered with the attached figures.

### DESCRIPTION OF THE DRAWINGS

FIG. 1 is a flow diagram illustrating a method in accordance with the present invention;

FIG. 1(a) is a flow diagram illustrating in detail a method comprising a step of establishing an account in accordance with the method illustrated in FIG. 1;

FIG. 1(b) is a flow diagram illustrating in detail a method comprising a step of activating an account in accordance with the method illustrated in FIG. 1;

FIG. 1(c) is a flow diagram illustrating in detail a method comprising a step of determining if access to an account is permitted in accordance with the method illustrated in FIG. 1;

FIG. 1(d) illustrates various flow diagrams of methods comprising a variety of methods of utilizing an accordance in accordance with the method illustrated in FIG. 1;

FIG. 2 illustrates on environment for account-based on-line electronic devices in accordance with an embodiment of the invention; and

FIG. 3 illustrates one example system including electronic devices in accordance with the invention.

### DETAILED DESCRIPTION OF THE INVENTION

The invention comprises one or more methods and apparatus for facilitating monetary and commercial transactions. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises one or more methods and apparatus for facilitating transactions, such as monetary funds transfers and purchases, and especially those occurring at least partially electronically. The invention also comprises methods and apparatus for facilitating commercial transactions, such as the purchase of goods and services.

In preferred embodiment, the methods and apparatus are utilized to facilitate the operation of one or more devices. In one embodiment, those devices are electronic devices associated with the Internet, the operation of which (or the operation of features thereof) is dependent upon authorization from at least one third party.

Various aspects of the invention comprise methods of creating and utilizing financial accounts.

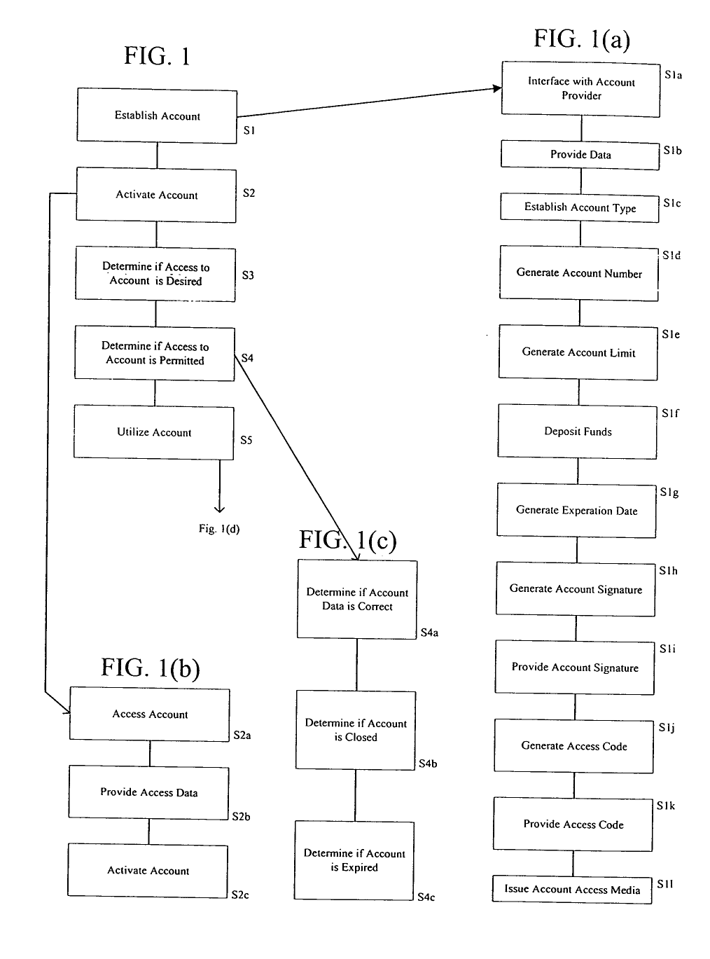

Referring to FIG. 1, one or more embodiments of a method of the invention will be described. First, in a step S1, an account is established. The account may be established by a party for use by themselves or for use by others. As used herein, the person who establishes the account is generally referred to as a customer, regardless of whether that person is establishing the account for themselves or another party or user.

The account is established by an account provider. The account provider may be a retailer, bank or other entity. As provided below, regardless of whether the account is referred to as a financial, bank, debit, monetary or other named account, the account has certain characteristics that define it.

Referring to FIG. 1(a) there will be described one or more methods for establishing an account. In a first step S1a, a customer interfaces with an account provider. This step may comprise the customer accessing a website belonging to the account provider, calling an account provider customer representative, or accessing one or more other means now known or later developed by which the customer may provide information to the account provider.

In a step S1b, the customer provides data to the account provider. This data is used to set up the account. The particular data which is required may vary by provider. In one or more embodiments, the data may include the customer's name and/or the name(s) of the parties which are to be permitted to access the account, address, telephone number, social security number, birth date, mother's maiden name and/or other information. In the event the customer is a business, the information may comprise the business name, address, telephone number, taxpayer identification number and/or similar information.

The particular manner by which this information is transmitted to the account provider may depend upon the interface the customer is using. For example, the data may be input into a graphical user interface associated with the account provider's website and then sent to the account provider's computer, such as over the Internet. The data may be provided orally over the phone by the customer to the account provider.

In a step S1c, an account type is established. In one or more embodiments, the account type may comprise one or more of the following: customer debit, charity debit, promotional, or allowance account.

A customer debit account is preferably of the type where funds belonging to the customer are assigned or credited to the account, and payments, transfers and the like are associated with debits of these funds from the customer's account. This is opposite to a credit type account where those funds which are debited belong to the account provider or other creditor with the requirement that the customer repay the account provider with their funds at a date after a particular transaction. In general, the customer debit account permits a customer to make and pay for purchases, obtain funds (such as currency), and transfer funds into and out of the account.

A charity debit account is preferably of the type where the customer may only transfer funds from the account to an authorized charity or similar entity, with no other debits permitted (except return of the funds to the customer or transfer of funds to another account belonging to another account at the specific instruction of the customer). Generally, the customer will provide the account provider specific information about the charity to which funds are to be transferred. The customer may arrange the account such that funds are debited and transferred to the charity at one or more predetermined times and for one or more predetermined amounts.

A promotional account is preferably of the type where the customer is a promoter arranging an account for use by one or more other parties. For example, the promoter may be a store owner and the parties who may use the account may comprise customers or potential customers of the store. The promotional account is arranged so that the parties or users may access the account in accordance with the terms of a promotion offered by the promoter. A promoter may establish an account having funds permitting a number of parties to pay for a certain dollar amount of goods purchased at their store via the promotional account. For example, a promoter may establish a promotion for a number of parties, such as 1000 existing customers, whereby $10 of each purchase from the promoter over $20 is payed for by the promoter. The $10 payment may be debited from the promotional account at the time each party makes a qualifying purchase to credit the parties' payment of the goods or services.

An allowance account is preferably of the type where funds are arranged to be periodically transferred into the account. Such an account may be extremely useful to parents having children. In accordance with this account arrangement, funds are periodically transferred into the account for subsequent use. The funds may be transferred from another established account, or an account or other source not associated with the account provider. For example, parents may establish a customer account from which funds are periodically transferred, such as every two weeks, into an allowance account which is accessible by one or more of their children. These children may access the allowance account to pay for books and the like. In this manner, the parents may control (and as described below, track) the spending of their children or other parties which have access to the account.

Those of skill in the art will appreciate that the particular type(s) of accounts and their various features or characteristics may be different than those provided above. For example, an account may have one or more features associated with more than one of the account types provided above.

In a step S1d, the account provider generates an account number and associates the account number with the account. The account number may be used by the account provider and customer to identify the account.

In a step S1e, the account provider assigns the account with a maximum funds value or value limit. In general, this value may be selected by the customer. Most often, the maximum value will comprise the amount of an initial deposit into the account by the customer. In one or more embodiments, the account provider may only offer accounts having pre-set limits, such as $50, $100, $250 or $500.

In a step S1f funds are deposited into the account. Preferably, the maximum amount of funds which may be deposited into the account does not exceed the funds maximum value associated with the account.

In one or more embodiments, the customer provides data which permits the account provider to obtain funds electronically. In one or more embodiments, this comprises providing the account provider with a routing number for a checking or savings account at a bank, account and access information for an ATM card linked to an account, or a credit card. In one or more embodiments, a customer may be permitted to deposit funds by mail or similar non or partially non-electronic manner.

In a step S1g, the established account is assigned an expiration date. In one or more embodiments of the invention, this step comprises associating date data with the account. The expiration date may be generated in a wide variety of manners. The expiration date may comprise a date which is determined by adding a fixed period of time to the date on which the account is established or, as described below, the date on which the account is activated. As described below, the account is arranged such that when the actual date reaches the expiration date, the account can not be accessed except by the account provider.

In a step S1h, an account signature is generated and associated with the account. The signature comprises a unique code or other element for establishing entitlement to access the account. In one or more embodiments, the account provider generates the code based on one or more elements of data associated with the account, such as customer provided data, the initial funds deposit amount, the account number, the account expiration date and/or one or more other elements. In one or more embodiments, the account signature is generated from, or includes, an access code or personal identification number (PIN) data assigned to or selected by the customer as described below. In one or more embodiments, the data used to generate the signature may be input into an encryptor to generate an output which comprises the account signature. The account signature may be generated randomly as well. Preferably, whatever means is used to generate the signature, each signature is unique for a particular account.

In a step S1i, the account signature is provided to the customer. In one or more embodiments, the account signature is mailed to the customer, told over the phone by a customer representative of the account provider to the customer, or is transmitted electronically to the customer. As described below, in the event the customer is provided with an account access media, then the account signature may be provided on the account media. The account signature may be printed on, embossed in, or encoded on the account media or an element associated therewith.

In a step S1j, an account access code is generated and associated with the account. In one or more embodiments, the account provider generates the access code. In other embodiments, the customer generates the code and provides it to the account provider. The access code may comprise a personal identification number or “PIN” comprising one or more letters and/or numbers.

In a step S1k, the access code is provided to the customer. In the case where the customer selects the access code, this step is completed at the same time as step S1h. When the account provider generates the code, the code may be mailed, electronically transmitted or spoken to the customer.

In a step S1l, in one or more embodiments, the customer is provided with an account access media. The access media may comprise a card, check, ticket, chip or a wide variety of other items. In one or more embodiments, the account signature is associated with the access media. When the access media comprises a card, check or the like, the account signature and/or account may be printed or encoded thereon. The account signature may be provided in one or two-dimensional bar code form or be encoded in a magnetic stripe or a chip or other data storage element associated with the media.

The account signature and/or access code may comprise a physical characteristic of the customer. For example, the access code may comprise a fingerprint or the customer's retinal features. In general, the account number, signature and access code are for use in identifying the particular account and ensuring that only those parties with authority to access an account can do so. A variety of other methods and devices may be used for these purposes.

A variety of other steps and maybe associated with the establishment of an account for the customer, and the steps described above need not be completed in the order in which they were described.

Referring again to FIG. 1, in a step S2, an account which the customer wishes to access is activated. Normally, this step will be in response to a customer wishing to access a newly established account.

Referring to FIG. 1(b), there is illustrated one embodiment of a method of activating an account in the event the account has not been activated. In a first step S2a, the customer accesses the account. In one or more embodiments, this step comprises a customer contacting the account provider, such as via a website of the account provider or by telephone with a customer service representative.

In a second step S2b, the customer provides their account number, signature and, in one or more embodiments, the access code. This account identification and access data may be provided by a customer telling an account representative the information, typing the information into a data input accepting element of a graphical user interface of a website, or otherwise transmitting such to the account provider. In one embodiment, the account number and signature may be scanned off of an account media provided the customer, such as with a magnetic stripe or bar code reader.

In a step S2c, the account provider activates the account. In one or more embodiments, this step comprises associating data with the account which indicates that the customer and/or other designated and/or appropriate parties may utilize and access the account.

The account activation may be accomplished in a wide variety of other manners. For example, in one embodiment, a customer may activate an account by simply calling a phone number of the account provider or entering the appropriate data into the account provider's website. In this arrangement, it is not necessary for the customer to access the account or provide all of the account information which may be necessary for the customer to use the account.

In one embodiment, an account may be activated for use by a customer at the time it is established. In such an arrangement, any access media associated therewith may be separately activated. For example, the account may be activated when established, allowing a customer to make deposits, funds transfers or the like through an account provider representative or website. However, the customer may not be permitted to utilize an account media (such as for purchases or cash withdraws) until the customer activates the account as to the media. The customer may activate an access card by calling a representative of the account provider after the card is received or other means.

Referring again to FIG. 1, in a step S3 it is determined if a customer wishes to access an account, as by a customer's attempted use of the account. This step may be remote in time from step S2, or at the same time. For example, a customer may activate an account shortly after establishing it, but not access the account for several days or weeks thereafter. A customer may also wish to activate an account and utilize it at the same time, such as when the customer wishes to pay for a purchase at a store.

In one or more embodiments, this step comprises determining if a customer is accessing a bank, automated teller, customer service representative, account provider website, remote payment station or the like. In order to determine if the customer is attempting to access an account, particular account information and associated access data is required. This data may be provided to the account provider or other account access controlling entity in a number of manners. In one or more embodiments, the account information may be directly provided by the customer, as through data input into a website or spoken to an account representative, or by reading the information from the access media.

The customer may wish to access the account for a number of reasons. For example, in the event a customer wishes to complete a purchase from a vendor, such as on-line or at a store, the customer may seek to access the account to pay for the purchase. The customer may seek access to the account to obtain funds from an automated teller machine.

In one or more embodiments, data must be provided to the account provider to establish the entitlement of the customer to access the designated account. This information may comprise the account signature and/or access code. Again, the particular means and/or method by which this information is provided may vary. In an embodiment where a customer is seeking to access an account using an access media, the account signature may be read or scanned from the card, and the access code may be provided by the customer, such as through a keypad. The customer may also provide such information through a variety of data input devices, such as a computer or customer station at a store, or provide the information directly to an account representative.

When a customer wishes to access an account, in a step S4 it is determined if the access to the account is permitted. In one or more embodiments, and referring to FIG. 1(c), this step includes a step S4a of determining if the provided account access information is correct and complete. In one or more embodiments, this step comprises comparing the provided account identification and/or access information to that associated with the account which the customer is seeking to access. If the required information has not been provided or is not correct, access to the account is denied. The customer may then be directed to contact the account provider and/or attempt to re-enter the required data in case there was an error in providing or transmitting it to the provider.

If the requisite access information is provided, then in a step S4b, it is determined if the account is closed. If the account has been closed, then access to the account is denied. The account may be closed at the request of the customer, upon violation of account terms and conditions or for a wide variety of other criteria or reasons.

If the account is not closed, then in a step S4c, it is determined if the account is expired. The account may be determined to be expired if a current date is the same as or time-wise later than the expiration date assigned to the account. If the account is expired, the customer is not permitted to access the account directly. Preferably, in that situation, the customer may access the account only through the account provider. The customer may contact the account provider and arrange for the removal of any funds remaining in the account. Alternatively, the customer may be permitted to re-activate the account with a new expiration date.

If in step S4 it is determined that access is permitted to the account, then in step S5, the customer is permitted to utilize the account. As described below, a variety of transactions, interactions with and manipulations to the account are permitted.

Referring to FIG. 1(d), in one or more embodiments, in a step S6, a customer is permitted to utilize the account to make a payment to a third party. A variety of methods may be implemented to effectuate this step. In one or more embodiments, in a step S6a, it is determined if the account is a charity account. If so, in a step S6b, funds are transferred from the charity account to a selected charity.

In one or more embodiments, when a charity account is established, the account provider designates the account a charity account. At that time, a customer may designate one or more charities to which funds placed in the account are to be distributed to. These funds may be distributed in accordance with the specific instruction of the customer at a later date, or at a predetermined time or in accordance with a predetermine schedule. The amount of the funds to be distributed may be designated by the customer as well. In one or more other embodiments, the customer may designate the charity(ies) to which funds are to be distributed after the account has been established.

In one or more embodiments, the funds which are distributed to the charity are transferred electronically from the account by the account provider to an account belonging to the charity or an intermediate escrow account or the like from which the charity may obtain payment. In other embodiments, the funds may be mailed or transmitted in other manners.

If the account is not a charity account, then it is determined in a step S6c if the account is a promotional account. If the account is a promotional account, then in a step S6c, the account may be used to purchase or pay for goods from specific parties. Preferably, the account provider must verify that the purchase is being made from one of the authorized parties. Normally, when the purchase is being made, the vendor will transmit vendor identification information along with the customer's account information. The account provider can verify the vendor from the provided vendor information.

If in step S6c it is determined that the account is not a promotional account, then it is determined that the account is a customer or allowance account which may be used as the source of payment for a transaction with, in general, any party. In step S6e, the purchase or other transaction is then facilitated by debiting the account.

It will be appreciated that a variety of steps other than those described may be associated with the payment of a purchase from the account. For example, in one step, the account provider must generally verify that sufficient funds exist in the account to permit the transaction. If sufficient funds do not exist, then the transaction may not be permitted. Alternatively, as described below, the account may be provided with a “credit” or “overdraft” feature which would still permit the customer to access the account.

As part of the transaction, the particular vendor may send information which facilitates the transfer of funds from the customer's account to the vendor's account by the account provider. For example, this information may comprise a vendor identification or account number.

As provided above, the method and apparatus by which the customer accesses the account to facilitate a purchase may vary. For example, if the customer is purchasing goods at a store, the customer may swipe their access media through a card reader and enter their access code. If the purchase is through a web-site or similar on-line access, the data may be input into a graphical user interface of the site.

In accordance with one or more embodiments of the invention, the payment for purchase may be arranged as an automated debit from the account. For example, a customer may arrange for payments to be made from the account on a periodic basis, such as in response to monthly amounts due a party (such as for a car payment or the like). In such event, the customer may provide the necessary debit information to the account provider.

In one or more embodiments, a purchase may be made in the form of an automatic funds transfer. For example, a customer may arrange with a particular vendor an arrangement where payment for the goods or services is made automatically. The customer provides the vendor with the account data which is then used by the vendor at one or more times subsequent thereto to affect payment. As an example, a customer may provide account data to their electric company. The electric company may then receive payment for the electricity supplied to the customer each month directly from the account through the account provider without intervention by or acts required by the customer. In this embodiment, the step of the customer accessing the account, step S3, generally comprises the customer providing the account data to the vendor or other party and then the vendor accessing the account as agent of the customer.

As one aspect of utilizing the account, as illustrated in FIG. 1(d), in a step S7, in one or more embodiments a customer may deposit funds into the account. A variety of methods may be implemented to effectuate this step. In one or more embodiments, this step includes a step S7a of determining if the account is an allowance type account. If so, then in a step S7b, funds are periodically transferred into the account. If the account is an allowance account, a customer will have provided the account provider with a source of funds from which a transfer into the account is to be made. The source of funds may be a customer's credit card, a bank account, or another account in accordance with the present invention. The customer will also have provided the account provider with specific instructions as to when funds are to be deposited, in what amount and the like.

If the account is not an allowance type account, then in a step S7c, the customer must specifically arrange for the particular transfer of funds with the account provider. For example, the customer may access a web-site or customer representative and provide source funds data. This data may comprise credit card information, bank account and routing information or the like. The customer may also arrange for funds transfer between accounts at a bank or similar provided customer station, phone controlled system or the like.

As one aspect of utilizing the account, as illustrated in FIG. 1(d), in a step S8, in one or more embodiments a customer may withdraw funds from the account. A variety of methods may be implemented to effectuate this step. In one or more embodiments, the funds withdrawal may comprise the issuance of currency such as U.S. or other dollars, or other media. In one or more other embodiments, the withdrawal may comprise the transfer of funds to another entity or account.

In general, when the customer desires to obtain currency, the customer travels to an automated teller machine (ATM), bank or similar currency dispensing location. In such event, the step of providing the requisite account data (see step S3) may comprise swiping an account media and inputting an access code. In the event the customer does not have an access media, the customer may provide the requisite data directly to a teller or other bank personnel for input into a system.

If the customer desires to withdraw funds and have the funds transferred into another account, the customer may be permitted to do such over the phone, via the account provider's web site, or at a bank or other location. In this regard, the number of locations at which a customer may effectuate the transfer is not constrained to locations where currency can be dispensed.

If the customer requests funds, and if such funds exist in the account, the customer is provided with funds. This step may include the step of transmitting the fund request to the account provider and the account provider comparing the amount of funds requested versus the total amount of funds in the account. If the funds exist, then the account provider may send a signal or other indication that it is permissible to dispense the funds.

In one or more embodiments, the customer is permitted to request currency or a transfer. If currency is requested, then currency is dispensed. If a transfer is requested, then the funds may be transmitted electronically to a new account. In the event the funds are to be transferred to another account, the customer provides the necessary information, such as the receiving account number and/or routing number and/or receiving party information.

As one aspect of utilizing the account, as illustrated in FIG. 1(d), in a step S9, in one or more embodiments a customer may obtain account information and manage their account. A variety of methods and devices may be utilized to effectuate this step. For example, a customer may call an automated telephonic information system, call a customer service representative or access a web site belonging to the account provider. In one or more embodiments, certain information and transactions may be permitted through an automated teller machine or similar remote access site.

In one embodiment, this step may include one or more of the following steps. In a step S9a, a customer may be permitted to obtain their account balance. The account balance may be provided on a viewing screen or printed on paper.

In one or more embodiments, in a step S9b, a customer may obtain the account limit for their account. The limit value may be displayed to the customer if the customer is located at a display, or may be printed onto a media, such as paper, and dispensed or mailed to the customer. If the customer is utilizing a phone system, the information may be transmitted over the phone.

In one or more embodiments, in a step S9c, a customer may change information associated with their account. This information may comprise their name, address, telephone number, the name(s) of parties permitted to access the account and the like.

In a step S9d, a customer may change their access code or similar access information. For example, in one embodiment, the account provider may assign the customer the access code when the account is established. In accordance with this step, the customer may change this access code to a code of their selection.

In a step S9e, a customer may obtain information regarding transactions associated with the account. This information may include information regarding fund deposits, withdraws and other transactions. In one or more embodiments, the customer may obtain information regarding an amount paid or transferred out of the account, the date of the transfer and the party to whom the amount was paid or transferred. The customer may obtain information regarding an amount deposited or transferred into the account, the date of the transfer and the origin of the funds.

In a step S9f, a customer may close the account. When closing the account, the customer may indicate to the account provider the location to which any funds remaining in the account are to be transferred.

In a step S9g, a customer may re-activate an account in order to change its expiration date. For example, before an account expires, a customer wishing to utilize the account for a longer period of time may elect to re-set the expiration date for the account. In one or more embodiments, the date is automatically set by the account provider, such as by adding a period of time to the current expiration date or the current date. In one or more other embodiments, the customer may select a new expiration date in the future.

As one aspect of utilizing the account, as illustrated in FIG. 1(c), in a step S10, in one or more embodiments a customer may change the status of the account. A variety of methods may be implemented to effectuate this step. In a step S10a, a customer may change the account type, such as from a customer account to a charity or other account, or vice versa. In a step S10b, a customer may merge one account with another account. For example, a customer having two accounts may wish to merge the accounts into a single account. A customer having one account may establish another and then merge or eliminate the first account in favor of the second.

Several examples of account merging are provided below:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After merging accounts into a new account:

John Doe's Debit Accounts

| Account Type | Balance | Status |
|---|---|---|
| $250 Debit Account | $0 Remaining | Closed |
| $150 Debit Account | $0 Remaining | Closed |
| $150 Debit Account | $150 Remaining | Active until Jun. 1, 2001 |

Alternatively, the owner of the accounts may wish to transfer the $100.00 remaining from the $250 account into the $150 account with $50.00 remaining. This would close the $250 debit account and establish a new balance of $150 in the $150 debit account. An example of this transaction is as follows:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After transferring the remaining amount into the $150 account:

John Doe's Debit Accounts

| Account Type | Balance | Status |
|---|---|---|
| $250 Debit Account | $0 Remaining | Closed |
| $150 Debit Account | $150 Remaining | Active until Apr. 1, 2001 |

A customer may also be permitted to close the account. If the account is empty, the account is simply closed by the account provider so that further access to the account by the customer is prevented. In the event funds exist in the account, the customer may be provided with the option of transferring the funds to another location or account, or obtain the funds from the account provider by mail.

In accordance with one or more embodiments of the invention, the account provider may provide a credit line or “overdraft” protection for the account. This option may be provided to the customer for free or upon payment of specific service charges. In accordance with this embodiment, in the event a customer wishes to withdraw funds from the account (whether to obtain currency, transfer to another account or payment for goods/services) in an amount greater than that which exists in the account, the account provider may supply the funds to the customer.

In one or more embodiments, the account provider may charge the customer a specific fee for utilizing the credit line, such as a per usage fee, interest or the like. In one or more embodiments, after a particular transaction which exceeds the amount of funds in the account, the account is frozen until sufficient funds are placed in the account or provided to the account provider to cover the funds deficiency.

One or more embodiments of the invention comprise apparatus for use in performing the above-described methods. As stated above, this apparatus may include an access media, such as a card, check, chip or the like. The apparatus may also include a wide variety of devices for interacting with the account provider and/or account. These devices may include some existing devices, such as existing bank teller machines, card reading devices, and data receiving and transmitting devices.

In one or more embodiments, a customer is permitted to establish and interact with their account via a website or similar on-line access. The website may include a graphical user interface designed to provide information to the customer and prompt and accept that information. The website may have multiple levels or pages. For example, the website may have a home page or “log-in” page which prompts a customer to either identify that they are a new customer and wish to establish or activate an account or identify themselves as an existing customer and have them provide the requisite account information.

If the customer is a new customer, the customer may be sent to a webpage at which information is provided to the customer about the various accounts which may be established. This or other pages may include prompts for providing the data necessary to establish an account.

If the customer is an existing customer and provides the necessary information to access the account (as in Step S3-S5 set forth above), then the customer may be presented with a menu page. At this page the customer may be selected with a menu of items from which to select. These items may be similar to those of steps S7-10. For example, a customer may be provided with a “manage account” item. Upon selecting this item, the customer may be presented with a number of sub-menu items. These items may comprise those items identified in steps S9a-f.

In one or more embodiments, a webpage may display account information for more than one account belonging to a customer. A variety of means may then be presented to the customer for use in manipulating these accounts. For example, a customer may then be permitted to “drop and drag” funds or the like from one account to another.

In one or more embodiments, the account provider has one or more devices adapted to store account information and receive and transmit account data, data representing funds transfers and the like. The account provider may have a system which includes a data storage device, a data input device and a data transmitting device. The data storage device may comprise one or more hard drives or similar elements used to store account data. Modems, servers or similar devices may be used to transmit and receive data. This system may include one or more processors arranged to process data.

The devices used to implement the present invention may be incorporated into existing systems facilitating monetary and commercial transactions. For example, the access media associated with an account in accordance with the present invention may be utilized with current card-reading devices.

In accordance with one or more embodiments of the invention, an account provider may issue accounts associated with access media which are available for purchase by customers. For example, an account provider may associate an account with an access media. The access media may have associated therewith an expiration date, account data and a maximum value. A customer may “purchase” the account and associated access media at a retail location. When the account provider is a bank, the bank may place access media on sale at retail locations such as grocery and retail stores.

A customer purchases the account and card by paying the retailer (who in turn pays the account provider). In one or more embodiments, the customer may thereafter access the account by activating the account. This may comprise calling the account provider after purchase. At that time, the account provider may provide the customer with an access code for use in using the access card. The access code could be provided on the card, but this arrangement has added security in that the account provider can ensure that the account is only accessed once it has been paid for.

In this embodiment, a customer may conveniently obtain a “pre-paid” account for themselves or for another party. The account may be used in similar fashion to a credit or ATM card, permitting purchases from any vendor and permitting access to cash from any of a variety of cash-dispensing locations.

It will be noted that in this embodiment, the step of establishing the account is generally accomplished by the account provider without input from the customer. In one or more embodiments, after purchasing or obtaining the access card, a customer may be required or permitted to provide additional information in order to access the account.

It is preferred that the access card indicate the expiration date of the access media. If the access media and associated account is expired, the purchase is not permitted. If the access media is about to expire, the customer may purchase it and, if the customer wishes to extend the expiration date, contact the account provider after purchase to do so. In one or more embodiments, the expiration data may not be printed on the access media, but when it is purchased scanned, read or the like by the vendor to ensure that it is still valid. When a purchase of an access media is made, the expiration data may then be reset a predetermine time from the purchase, with this information scanned onto the card or otherwise associated with the account.

In the above-described arrangement, each access media, once paid for, generally has the same characteristics as cash. A customer may pay for goods using the purchased access media. A customer may deposit the funds associated with the access media into another account, or transfer it to another party.

The present invention has numerous benefits and advantages. First, an account of the present invention is configured to permit minors to make financial transactions. In accordance with the invention, a debit account is established by or for the minor. Because of the existence of the funds in the account, a minor may complete a transaction without concern to the account provider/financial institution that the minor will pay for goods.

In one or more embodiments, this arrangement permits a customer to “buy” an account for use by another person in a fixed amount. In this manner, the account may be used as a gift. This arrangement has the advantage that the recipient of the account can utilize the funds associated with the account to make a purchase or pay for goods/services from essentially any location. The recipient may purchase goods on-line or at a store. The recipient is not limited to a particular store or mall.

The customer may also utilize one or more of the accounts in similar fashion to travelers checks. Because the funds associated with the accounts are different, a loss such as by theft of a single access media does not affect the remaining funds. For added security, each access media may have a different access code.

Parents and others may arrange an account for their children. The children are not permitted to spend more money than their parents provide, because of the arrangement of the account. On the other hand, the parents can provide their children with a convenient means for paying for items even though they may be located a great distance apart. The parents may also access the account to track purchases and other transactions by their children. The parents may also arrange the account as an “allowance” account, where funds are placed into their children's account at predetermined intervals without specific action by the parents or children at the time of each deposit.

The methods and accounts of the present invention has several safety features. Because the account expires after a predetermined time, the risk that a thief may find and be able to use a lost access card is reduced. The account is associated with a unique account signature which is generated from data which is difficult to obtain.

The methods and accounts permit a wide range of transactions, including a number of very specific transactions which are not presently facilitated. For example, a vendor may establish promotional accounts for current and potential customers. One advantage of a promotional account is that a large company may establish accounts which customers can use at one or more of their stores located in different areas. For example, a retailer having outlet in Los Angeles and New York may issue cards associated with accounts for use by customer at either location. This arrangement is also advantageous for franchisees: the franchiser may sponsor a promotion for their franchisees whereby the discount or amounts provided to the customers are paid for by the franchiser.

A promotional account may also be a prize or award. A vendor may award an account to one or more customer who win a contest or drawing or the like. A vendor may also arrange the promotional account with an expiration date requiring the customer to utilize the account within a predetermined time.

A customer may establish a charity account for themselves, or a charity may establish an account for a customer. For example, a charity may seek donations from customers in the form of deposits into a charity account established by the charity for the customer.

In one or more embodiments, a customer or other user of a promotional account may be prevented from any account activities except use of the account to facilitate a purchase. The customer or user to whom the account is issued may be prevented from obtaining funds from the account (such as cash) or viewing data associated with the account such as the remaining balance or the like. A customer may also be prevented from merging the account or adding funds to the account. On the other hand, a vendor may be permitted to track all purchases and other uses of promotional accounts. In this manner, the vendor can obtain important data regarding the customer, including their spending habits, spending locations and similar information.

A business may use the account for business to business transactions. For example, a business may set up a master account and a number of sub or allowance accounts. The business may use the accounts to pay suppliers of goods and services. The master account may comprise a main account for the business and each allowance account an account relating to a particular vendor or project. Commensurate with billing or an accounting period, the business may have arranged an automatic transfer of funds from the master account to one or more of the allowance accounts, and from one or more of the allowance accounts to each particular supplier for their bill.

One embodiment of the invention is a method of utilizing an account to facilitate operation of an electronic device, and a system including one or more of such devices and a financial account.

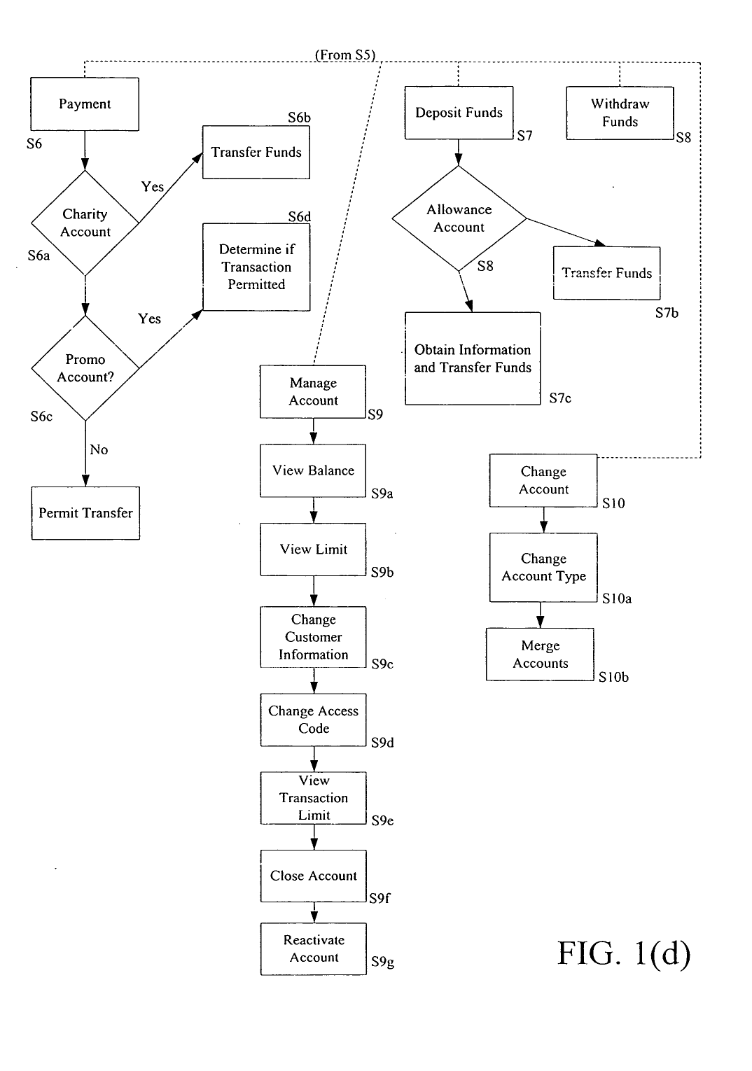

FIG. 2 illustrates one embodiment of an environment in accordance with an embodiment of the invention. As illustrated, the environment includes one or more electronic devices 200. These devices 200 communicate, at one or more times, with one or more remote devices via a communication link. In a preferred embodiment, the communication link includes a network, and more preferably, the Internet 202.

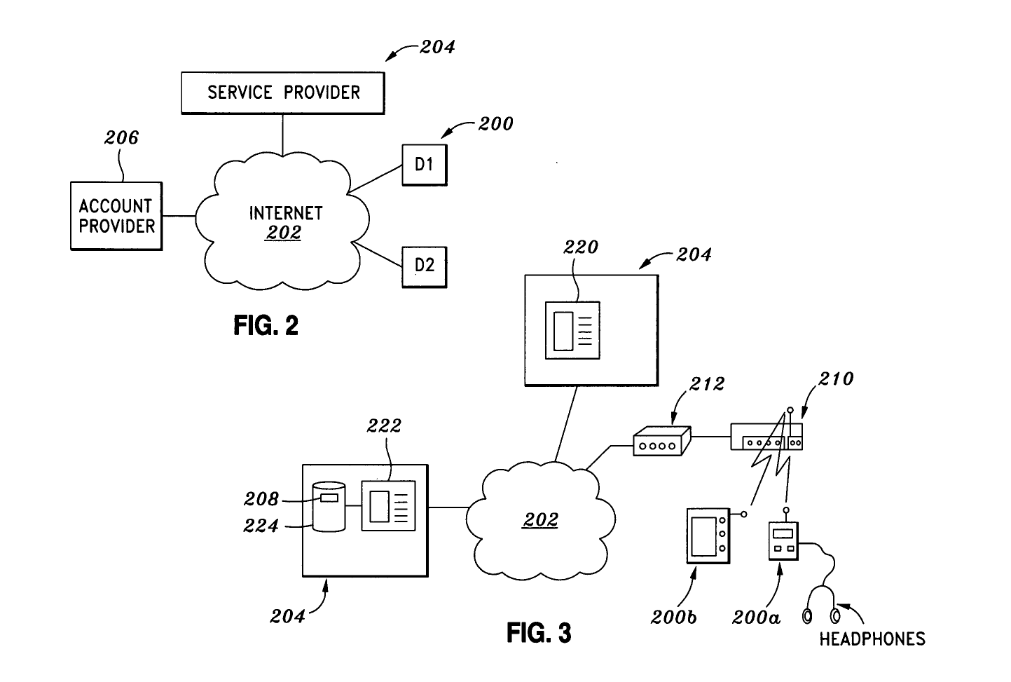

The devices 200 may comprise a wide number of devices. FIG. 3 illustrates various devices 200, it being understood that the invention is not limited to those devices. Each device 200 preferably comprises a computing device including a processor configured to execute instructions, such as in the form of machine readable code, and a memory. Each device 200 includes a communication interface, such as a wired or wireless transceiver, permitting the device 200 to send and receive information. The transceiver may be combination of hardware and/or software and may enable communications in accordance with a variety of standards now known or later developed.

One such device 200 may be a music player 200a. The music player 200a may include a memory for storing data representing music. The processor of the device may utilize that data to cause a sound generating device, such as a speaker or headphones, to generate sound. In one embodiment, the music player 200a may be configured to obtain data representing desired music content from a remote location.

The device 200 may be an image display device 200b, such as an “electronic picture album” display. The device 200b may again include a memory for storing data representing one or more images. The device 200b preferably includes a display, such as an LCD, plasma or other electronic display device. In one embodiment, the device 200b may be configured to obtain data representing one or more images from a remote location for storage and then display.

In yet another embodiment, the device 200 may be configured to obtain other information, such as: a meal menu or cookbook service where meals can be selected and recipes assessed and accessed; a grocery inventory permitting grocery items to be selected for delivery; a restaurant service where reservations may be made or menus perused and orders placed; and motion picture menus and data representing motion pictures for display to the user, among other things. In such configurations, the device 200 may include a display for displaying menus, recipes and the like. The device may also include or be connected to a printer, permitting the user to print a recipe or the like onto a tangible medium. The device 200 may be specifically configured to obtain and present such information, such as from a single source or vendor, or may be configured to obtain and present information of a variety of types and/or from a variety of sources.

Other devices 200 include telephones, weather stations, televisions or other moving image display devices, and a wide variety of other computing devices.

Referring again to FIG. 2, in one embodiment, the device 200 is configured to communicate with a remote device, such as to a service provider 204. For example, in the case of the music player 200a, the service provider 204 may be a music content provider. In the case of the image display device 200b, the service provider 204 may be an entity which stores images belonging to the user of the device 200b for selective download and use at the display device 200b, and/or which provides a selection of third party images for use by the user.

Preferably, one or more of the devices 200 are configured so that one or more functions thereof will not operate without authorization. In one embodiment, the service provider 204 enables operation of the device 200 or one or more features thereof. In the above-described example, the service provider 204 offers data which may be utilized by the device 200, such as data necessary to generate desired music or images. The service provider 204 may enable other aspects of the operation of the device 200. For example, in one embodiment, the service provider 204 may issue authorization codes or similar information which enables operation of one or more features of the device. For example, in the case of a personal weather station which downloads weather information via the communication link for posting to the user, the “download” feature of the station or the display of that information may not be activated.

Of course, a different service provider 204 may correspond to one or more of the devices 200. For example, a music download service may comprise the service provider for the music player 200a, while a photo provider may comprise the service provider for the image display device 200b.

In one embodiment, the service provider 204 only enables operation of the device 200, such as by providing the desired information, if the user or owner of the device pays for the right to use the device or obtain the desired information. For example, in the case of the music player 200a, the user may be required to pay a fee for each “song” which is obtained. Other services may be charged by time of service (e.g. daily, monthly or the like). As one example, in the case of a personal weather station, a monthly subscription fee may be paid to obtain updated weather information during that period of time.

In a preferred embodiment of the invention, a financial account is utilized to facilitate the financial transaction between the user/owner of the device 200 and the service provider 204. Preferably, the account has one or more of the aspects described above. The account may be provided or administered by an account provider 206.

Various aspects of the use of an account to facilitate operation of a device will now be described in more detail.

Referring to FIG. 3, in one embodiment, a user establishes a financial account 208 with the account provider 206. This may be accomplished as described in greater detail above.

In a preferred embodiment, a user establishes a financial account 208 corresponding to a particular device 200. For example, upon purchasing a music player, the purchaser may establish a financial account 208 corresponding to that device.

In a preferred embodiment, the device 200 is configured to provide information for associating the device 200 with the financial account 208. In this manner, payment for activation of the device 200 or one or more features thereof, including the obtaining of information for use by the device 200, may be confirmed.

In one embodiment, the device 200 is configured to store information which identifies the financial account 208. This information may then be transmitted from the device 200, such as to the service provider 204, for use by the service provider 204 in accessing the financial account 208 to obtain payment.

In another embodiment, financial account information may be provided to the service provider 204 and the service provider 204 may store than information. Preferably, the financial account information is associated with the device 200. When the device 200 is operated, such as by seeking an activation key or a download of information, the device 200 preferably transmits identifying information to the service provider 204. The service provider 204 utilizes that information to access the financial account associated with the device 200.

In general, in this manner, the service provider 204 is able to obtain any necessary payment associated with the activation or use of the device 200. In particular, the service provider 204 can utilize the financial account information to access the financial account, such as through contact of the account provider 206, to obtain payment from funds associated with the account.

One specific example of the invention will be described with reference to FIG. 3. As illustrated, a user has an image display device 200b. The device 200b comprises an electronic display, a memory, a controller or CPU, and an information or data transceiver. In the embodiment illustrated, the transceiver includes or comprises a wireless transceiver. The device 200b thus communicates wirelessly with one or more other devices.

In the embodiment illustrated, the device 200b communicates with a router 210. Such routers 210 are well known and thus will not be described herein in detail. In general, the router 210 collects information from multiple devices and is capable of distributing information to multiple devices. As illustrated, the router 210 is in communication with a modem 212. The modem 212 preferably serves as a communication interface with a communication network. In the embodiment illustrated, this network is the Internet 202.

A service provider 204 and an account provider 206 operate one or more computing devices, such as servers 220,222, which are in communication with the Internet (or other communication link to the electronic devices). These servers are capable of accepting information directed to them over the Internet and transmitting information to other devices over the Internet.

The user establishes a financial account 208 (which as illustrated is represented as an electronic file stored in a memory device 224). This may be done prior to the user obtaining the device 200b, or at the time the device is acquired or thereafter. For example, the user might establish an account at the time they purchase the device. The creation of the account may be facilitated by the service provider or the seller of the device or service, or even be directly offered by those entities.

Preferably, the user provides information to the service provider 204 which identifies them and/or their device 200b. In one embodiment, the user may register their device 200b. For example, in one embodiment, the user causes the device 200b to establish a communication link with the service provider 204. For example, upon turning the device 200b on, the device 200b may search for and attempt to establish a communication link with the service provider. The device 200b may then transmit information which identifies itself to the service provider 204, such as by a unique serial number or i.d. or the like. Alternatively, or in addition, the user may provide information to the service provider 204. For example, the user may input their name, address and other information into a user interface which is displayed by the device 200b, the device 200b then transmitting that information to the service provider.

In one embodiment, means are provided for associating the user's account with the service provider 204, either directly or indirectly, so that the user may establish entitlement, by financial payment, for the right to use the device 200b and/or the right to information for the device.

In one embodiment, the user may input this information into the device 200b, such as by input into a graphical user interface displayed by the display, a keyboard or other input device. The device 200b may then store the financial account information. The financial account information may comprise, for example, an account number.

In one embodiment, when user attempts to utilize the device 200b, the device may establish a link with the service provider 204 to confirm enablement and operation. The service provider 204 may maintain an account corresponding to the device 200b and/or user. The account may include information regarding whether the user has paid for the right to use the device. If so, then the service provider 204 may send a signal back to the device 200b indication that operation is permitted. If not, the service provider 204 may send a signal to the device 200b requesting the financial account information. The device 200b may then transmit that information, such as the account number associated with the device/user, to the service provider. The service provider may then utilize that information to contact the account provider 206 and obtain payment for the service from the user's financial account.

In another embodiment, the service provider 204 may transmit a “key” to the device 200b which enables the device for a period of time. The key may be active for a period of time the user has paid for a subscription of use. After that time, the key may expire. If the key is active, the device 200b may operate. For example, when the device is turned on or during cycles of operation, the device may be configured to check for an active key. If the key is active, the device may not contact the service provider. If the key expires, the device 200b may inform the user and attempt to contact the service provider 204 to establish payment for a new subscription and to re-activate the key or obtain a new key.

A similar method of operation may be applied if the user wishes to obtain information from the service provider 204. For example, the user may wish to utilize the device 200b to download photos and display them on the device. The device 200b may contact the service provider 204 and the service provider 204 may transmit information regarding various images the user may access. If the user wishes to access certain images, there may be a cost for doing so. The service provider 204 may permit access to those images once the user has provided their financial account information or the financial account information has been verified relative to the electronic device through which the request is being made.

The service provider 204 may contact the account provider 206 in a variety of ways. In one embodiment, this may be via the Internet. In other embodiments, the service provider 204 may charge payment to the financial account through a financial institution, such as a bank of the service provider 204.

Of course, a wide variety of variations are contemplated as within the scope of the invention. For example, the devices may be configured to communication using various communication methods and pathways, such as dedicated lines and the like. The user may provide information to the service provider in a variety of ways other than by providing the information to the device 200 and then having the device transmit some or all of the information to the service provider.

For example, in one embodiment, when a user purchases or obtains a product, they may provide financial account information directly to the service provider 204. The service provider 204 may store that information along with either an identification of the device which the user wishes to associate with that account and/or the identification of the user. When the user utilizes the device at a later time, the device identifies itself to the service provider, and the service provider then utilizes the associated financial account information to obtain payment.

In one embodiment, the service provider 204 will only permit the requisite data (such as the activation “key” or other data which the user desires to download, to be transmitted if payment from the user's financial account can be confirmed. This may require, for example, that the user properly fund the financial account to ensure that payment is made.

As described, in one embodiment, a financial account is associated with a single device. In this configuration, the user may elect or may be required to create a separate financial account for each and every device which the user wishes to operate.

In another embodiment, a user may associate a plurality of devices with a single account. In the illustrated embodiment in FIG. 2, for example, the user may associate all of the devices 200 with a single account. In another embodiment, the user may associate some of the devices 200 with one account and other of the devices with one or more other accounts.

In one embodiment, use of the device 200 may be facilitated by a management service. For example, a user may register their device with a management service. Each time a user engages in a transaction using the device 200, that transaction may be facilitated by the management service. The management service may also be the account provider in one embodiment.

As one example, the management service may provide information regarding a plurality of services or goods. A user might select “recipes” from the provided information. The management service might either then directly transmit recipe information, route the user to a source of recipe information (such as a website offering such information), or route such information to the user from a third source. Once the user has selected a recipe, the management service might pay the provider of that information for the recipe via the use's financial account. In the event the user wishes to obtain the ingredients for the recipe, the management service might then direct the request for groceries to a local grocery provider who then delivers the groceries to the user. Once again, the management service may utilize the user's financial account o facilitate payment for the purchase and delivery of those goods.

The management service/service prover may facilitate payment to the third party on behalf of the user in a variety of ways. For example, the third party may transmit account/financial information to the management service, who then utilizes that information and the user's financial account information to transfer funds from the user's account to the third party's account. In another embodiment, the management service may transmit user financial account information to the third party and the third party may utilize that information to directly access the user's account and obtain payment. In this configuration, the third party may transmit an acknowledgment to the management service. This acknowledgment might include, for example, confirmation of the amount charged to or debited from the user's account and/or confirmation of the order for goods/services.

This aspect of the invention has numerous advantages. First, a convenient means is provided for providing payment for the enabling of the operation of electronic devices, including obtaining information for use with or by those devices. It will be appreciated that the configuration of the invention may be utilized to enable operation of a device for a third party. For example, a parent may purchase a music player for their child. The parent may establish and fund a financial account, thereby ensuring control over the activities of the child relative to expenditures for music downloads and the like.

The configuration of the invention is also particularly suited to situations where such devices are given as gifts. In such a situation, the gift giver may establish and fund a financial account with a certain amount of funds. The recipient may then utilize the device without having to make any payment, for at least some period of time, but by the funds coming from the financial account.

The linking of the financial account to the device has a number of additional advantages. For example, in the case of the ordering or food, groceries, tickets (such as airline tickets/concert tickets and the like) or obtaining information such as recipes and the like, the selections can be made and payment is automatic since the device is associated with a financial account. Thus, the provider/vendor does not need to separately obtain payment and the user does not need to additionally provide payment information. For example, a user may order food for delivery from a local restaurant. Instead of having to pay for the food at the time it is picked up or delivered, payment is automatic at the time the food is ordered. In addition, the vendor does not need to discuss the order and payment with the user of the device, as the entire order can be automated.

The various aspects of the financial accounts described above have particular applicability to this aspect of the invention. For example, the use of a separately funded account for such devices ensures that payment comes from an account separate from a main checking account or the like, where abuses, theft or the like would have a detrimental effect. As described, the financial account may be funded for third partes, and accounts may be merged, transferred or the like.

It will be understood that the above described arrangements of apparatus and the method therefrom are merely illustrative of applications of the principles of this invention and many other embodiments and modifications may be made without departing from the spirit and scope of the invention as defined in the claims.

1. A method for enabling the operation of one or more functions of an electronic device comprising:
providing information for establishing a financial account;
funding said financial account with value;
obtaining an electronic device;
providing information which identifies said financial account;
establishing a communication link between said electronic device and a remote service provider;
transmitting information for identifying said financial account; and
receiving information enabling one or more functions of said electronic device if said financial account is verified and payment for use of said one or more functions of said device is obtained by said service provider.

2. The method in accordance with claim 1 wherein said financial account is established by a financial account provider separate from said service provider.

3. The method in accordance with claim 1 wherein said step of providing information which identifies said financial account comprises providing an account number.

4. The method in accordance with claim 1 wherein said step of establishing a communication link comprises establishing a communication link over the Internet between said device and a server of said remote service provider.

5. The method in accordance with claim 1 wherein said step of transmitting information for identifying said financial account comprises said electronic device transmitting information identifying said device to said service provider.

6. The method in accordance with claim 1 wherein said step of transmitting information for identifying said financial account comprises said electronic device transmitting account number information.

7. The method in accordance with claim 1 wherein said step of receiving information comprises receiving a key which enables operation of said device.

8. The method in accordance with claim 1 wherein said step of receiving information comprises receiving information for use by said device in providing an output.

9. The method in accordance with claim 8 wherein said device includes an audio producing device and said providing an output comprises generating music with said audio producing device.

10. The method in accordance with claim 8 wherein said device includes a video display and said providing an output comprises generating at least one image with said audio producing device.

11. A method of enabling the operation of at least one function of an electronic device comprising:
a service provider receiving information identifying said device and a financial account over a communication link between a computing device of said service provider and said electronic device, at least a portion of said communication link comprising the Internet;
said service provider utilizing said information identifying said financial account to contact a provider of said financial account and obtain payment from funds associated with said account;
said service provider configuring information for use by said electronic device in operating at least one function of said device;
said service provider transmitting said information to said device over a communication link, at least a portion of said communication link comprising the Internet.

12. The method in accordance with claim 11 wherein said information identifying said device comprises a device i.d.

13. The method in accordance with claim 11 wherein said information for use by said electronic device comprises a key.

14. The method in accordance with claim 13 wherein said key has an expiration date.

15. The method in accordance with claim 111 wherein said information enables presentation of information regarding one or more goods or services which the user may select.

16. The method in accordance with claim 15 including the step of said user selecting one or more goods or services.

17. The method in accordance with claim 16 wherein said good comprise groceries and including the step of said service provider contacting a grocery provider and requesting purchase of the requested groceries on the user's behalf.

18. The method in accordance with claim 17 including the service provider facilitating payment for said groceries using said financial account.

19. The method in accordance with claim 11 wherein said configuring information enables display of information regarding one or more goods or services offered by a third party by said user, and including the steps of said service provider receiving input from said user of a selected good or service, said service provider contacting said third party provider regarding said user's selection, and said service provider facilitating payment for said selected goods or service via said financial account.

20. The method in accordance with claim 19 including the step of said service provider transmitting information identifying said financial account and said third party transmitting back to said service provider a request acknowledgment.

21. The method in accordance with claim 11 wherein said information for use by said electronic device comprises information for use by said device in creating and audible or visible output.
